(19) United States
(12) Patent Application Publication
(10) Pub. No.: US 2011/0235625 A1
(43) Pub. Date: Sep. 29, 2011

(54) COMMUNICATION TERMINAL AND RELAY STATION USING LOCAL WIRELESS COMMUNICATION AND SERVICE PROVIDING METHOD THEREOF

(75) Inventor: Jong-Bae LEE, Suwon-si (KR)

(73) Assignee: SAMSUNG ELECTRONICS CO. LTD., Suwon-si (KR)

(21) Appl. No.: 13/073,079

(22) Filed: Mar. 28, 2011

(30) Foreign Application Priority Data
Mar. 26, 2010 (KR) 10-2010-0027312

(51) Int. Cl. H04W 4/00

(52) U.S. Cl. 370/338

(57) ABSTRACT

A device and method for providing a communication service using local wireless communication are provided. A communication terminal for servicing wireless communication with a relay station includes a local wireless communication unit for transmitting and receiving an audio signal for a Voice over Internet Protocol (VoIP) service through wireless communication with the relay station, for converting a radio signal received from the relay station into a digital audio signal to output the digital audio signal, and for converting an input digital audio signal into a radio signal to transmit the radio signal to the relay station; and an audio processor for converting the digital audio signal received from the local wireless communication unit into an analog audio signal to output the analog audio signal, and for converting an input analog audio signal into a digital audio signal to deliver the digital audio signal to the local wireless communication unit. By providing a VoIP service using local wireless communication, coverage of the terminal may be expanded, contributing to a reduction in system complexity and power consumption of a communication system providing the VoIP service.

### PRIORITY

This application claims the benefit under 35 U.S.C. §119(a) of a Korean patent application filed in the Korean Intellectual Property Office on Mar. 26, 2010 and assigned Serial No. 10-2010-0027312, the entire disclosure of which is hereby incorporated by reference.

### BACKGROUND OF THE INVENTION

1. Field of the Invention

The present invention relates to a communication method and device. More particularly, the present invention relates to a device and method for providing communication services using local wireless communication.

2. Description of the Related Art

The Internet, an open network built to allow a user to freely connect his/her computer to a third party's computer using a common protocol referred to as Transmission Control Protocol/Internet Protocol (TCP/IP) is used not only to provide basic text information, but also to provide a variety of multimedia information. The availability of multimedia information has increased with the development of compression technology and increased network bandwidth.

The Internet has evolved to include broadband multimedia networks capable of transmitting voice data and video data with the rapid development of communication technology and in response to the growing needs of users. With the increasing demands of users for interworking between the internet and the traditional telephone networks, Voice over Internet Protocol (VoIP) technology has emerged recently, which is which is utilized to provide an Internet phone service.

VoIP technology is an Internet telephony technology supported to packetize and transmit not only normal data but also voice data using the Internet IP layer. VoIP services using VoIP technology are being focused on as application services on the Internet because the VoIP services can reduce call charges, enable Point-to-Multipoint (PtM) calls, and provide various additional services. The consumer market for VoIP services is growing and spreading as its market share is expected to grow by 40% within the next few years, replacing the wired phones. A communication system providing the VoIP service may be implemented by integrating an existing IP network and existing phone services, and has advantages of significantly reducing a cost of lines, which was spent for wired phones and fax transmission.

In the communication system using the VoIP service, a conventional terminal is connected to an RJ 11, a communication interface of a wired telephone network such as Public Switched Telephone Network (PSTN), and accesses a relay station (e.g., a set-top box) through a Subscriber Line Interface Circuit (SLIC). In the communication system, a terminal should include a high-voltage circuit to access the SLIC.

As described above, since the conventional terminal used to provide the VoIP service is a wired terminal connected to the RJ 11, the terminal has the limited call coverage (or mobility), and should include a high-voltage circuit to access the SLIC, leading to an increase in circuit complexity and power consumption.

Therefore, there is a need for a method capable of reducing circuit complexity and power consumption without the limited call coverage in a communication system providing a VoIP service.

### SUMMARY OF THE INVENTION

Aspects of the present invention address at least the above-mentioned problems and/or disadvantages and provide at least the advantages described below. Accordingly, an aspect of the present invention is to provide a device and method for providing a Voice over Internet Protocol (VoIP) service using local wireless communication.

Another aspect of the present invention is to provide a VoIP service providing device and method with the reduced circuit complexity and power consumption.

Another aspect of the present invention is to provide a device and method for transmitting a control signal for controlling an external device using a local wireless communication interface used to provide a VoIP service.

In accordance with one aspect of the present invention, a communication terminal for servicing wireless communication with a relay station is provided. The communication terminal includes a local wireless communication unit for transmitting and receiving an audio signal for a VoIP service through wireless communication with the relay station, for converting a radio signal received from the relay station into a digital audio signal to output the digital audio signal, and for converting an input digital audio signal into a radio signal to transmit the radio signal to the relay station, and an audio processor for converting the digital audio signal received from the local wireless communication unit into an analog audio signal to output the analog audio signal, and for converting an input analog audio signal into a digital audio signal to deliver the digital audio signal to the local wireless communication unit.

In accordance with another aspect of the present invention, a relay station for servicing wireless communication with a terminal is provided. The relay station includes a local wireless communication unit for transmitting and receiving an audio signal for a VoIP service through wireless communication with the terminal, for converting a radio signal received from the terminal into a digital audio signal to output the digital audio signal, and for converting an input digital audio signal into a radio signal to transmit the radio signal to the terminal, and a controller for transmitting the digital audio signal received from the local wireless communication unit to a communication network, for converting a digital audio signal received from the communication network into a radio signal, and for delivering the radio signal to the local wireless communication unit.

In accordance with further another aspect of the present invention, a method for providing a service in a communication terminal servicing wireless communication with a relay station is provided. The method includes converting an analog audio signal input from a user into a first digital audio signal, converting the first digital audio signal into a radio signal, transmitting the radio signal to the relay station, converting a radio signal received from the relay station into a second digital audio signal, converting the second digital audio signal into an analog audio signal, and providing the analog audio signal to the user.

In accordance with yet another aspect of the present invention, a method for providing a service in a relay station servicing wireless communication with a communication terminal is provided. The method includes converting a radio signal received from the communication terminal into a digital audio signal, transmitting the digital audio signal to a communication network, converting a digital audio signal received from the communication network into a radio signal, and transmitting the radio signal to the communication terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a conceptual diagram illustrating a configuration of a communication system according to an exemplary embodiment of the present invention;

FIG. 2 is a block diagram of a terminal according to an exemplary embodiment of the present invention;

FIG. 3 is a block diagram of a terminal according to another exemplary embodiment of the present invention;

FIG. 4 is a flowchart illustrating an operation of a terminal in a communication system according to an exemplary embodiment of the present invention;

FIG. 5 is a flowchart illustrating an operation of a terminal in a communication system according to another exemplary embodiment of the present invention; and

FIG. 6 is a flowchart illustrating an operation of a relay station in a communication system according to exemplary embodiments of the present invention.

Throughout the drawings, the same drawing reference numerals will be understood to refer to the same elements, features and structures.

### DETAILED DESCRIPTION OF EXEMPLARY EMBODIMENTS

Accordingly, those of ordinary skill in the art will recognize that various changes and modifications of the embodiments described herein can be made without departing from the scope and spirit of the invention. In addition, descriptions of well-known functions and constructions may be omitted for clarity and conciseness. The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As described above, in the conventional communication system providing a Voice over Internet Protocol (VoIP) service, its terminal is a wired terminal having limitations on mobility and movement, and should include a high-voltage circuit to access a Subscriber Line Interface Circuit (SLIC), leading to an increase in circuit complexity and power consumption.

An exemplary embodiment of the present invention provides a communication system having improved mobility, a simplified circuit, and low power consumption by using local wireless communication in a communication system providing a VoIP service.

Another exemplary embodiment of the present invention provides a method capable of improving user convenience by making it possible to control an external device using a local wireless communication interface used to provide a VoIP service.

ZigBee communication will be discussed below as an example of local wireless communication in the following description of exemplary embodiments of the present invention. However, the present invention is not limited thereto, and the local wireless communication scheme, protocol or method used according to exemplary embodiments of the present invention may be other suitable local wireless communication schemes, protocols or methods, such as Bluetooth.

Exemplary embodiments of the present invention will be described in detail with reference to the accompanying drawings.

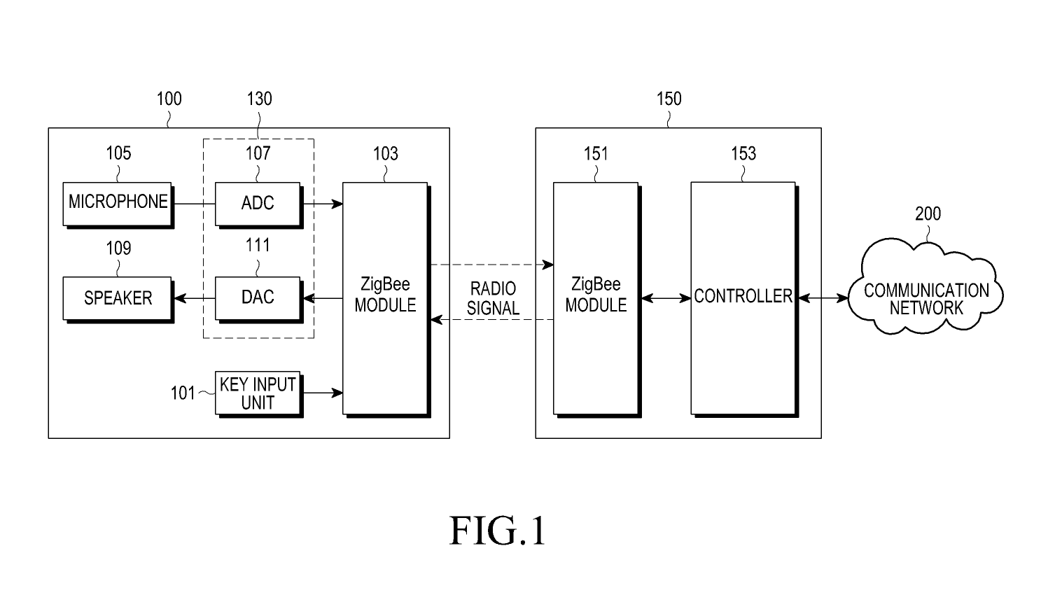

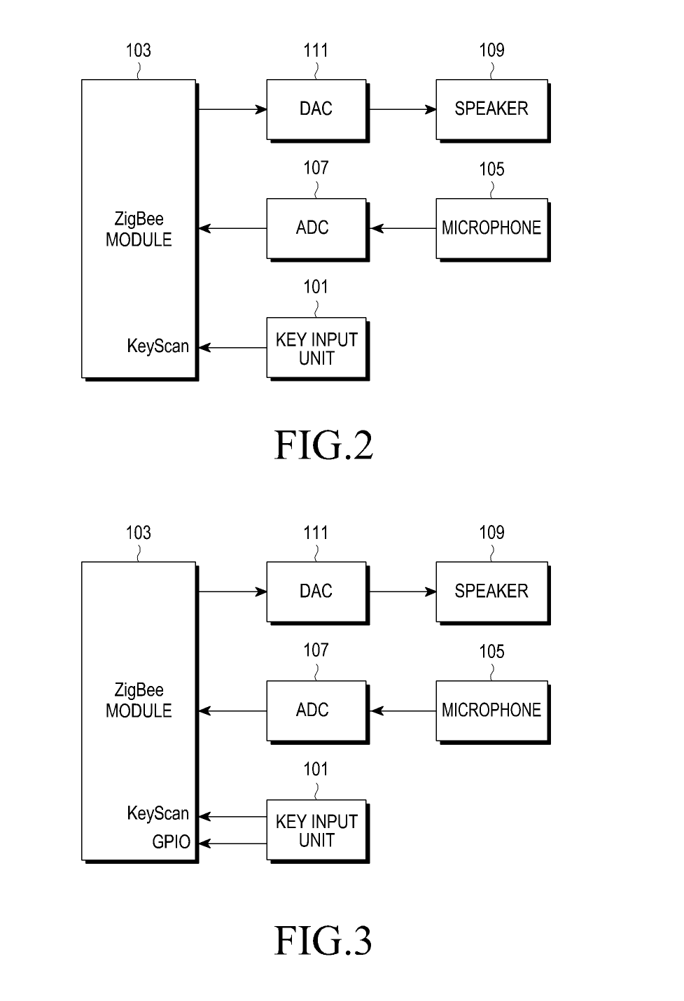

FIG. 1 illustrates a configuration of a communication system according to an exemplary embodiment of the present invention, and FIG. 2 illustrates a structure of a terminal according to an exemplary embodiment of the present invention.

Referring to FIGS. 1 and 2, a communication system, according to an exemplary embodiment of the present invention, includes a terminal 100 and a relay station 150.

The terminal 100 and the relay station 150 perform wireless communication with each other using respective local wireless communication modules, namely, ZigBee modules 103 and 151, respectively. The relay station 150 delivers a radio signal received from the terminal 100 to a communication network 200 after performing signal processing on the received radio signal. Also, the communication network 200 delivers a signal received from the communication network 200 to the terminal 100 after performing signal processing on the received signal. The communication network 200 includes various wired and wireless networks.

The terminal 100, according to an exemplary embodiment of the present invention, includes a key input unit 101, a ZigBee module 103, a microphone 105, an audio processor 130, and a speaker 109.

The key input unit 101 includes at least one numeric key for receiving at least one number, such as a phone number or an extension number for calling the other party's terminal, from a user. The key input unit 101 generates a signal corresponding to an input number and delivers the generated signal to the ZigBee module 103. When ZigBee communication is used as local wireless communication, the key input unit 101 is connected to a KeyScan pin of the ZigBee module 103, and the ZigBee module 103 converts a signal corresponding to at least one number being input through the KeyScan pin into a radio signal. The radio signal is transmitted to the relay station 150 relaying VoIP communication.

The ZigBee module 103 delivers a digital audio signal received from another party's terminal through the relay station 150 to the audio processor 130. To be more specific, for example, a transmission port (e.g., an I2S Tx pin) of the ZigBee module 103 may be connected to a Digital-to-Analog Converter (DAC) 111 in the audio processor 130. Also, the ZigBee module 103 delivers a digital audio signal received through the relay station 150 to the DAC 111.

Additionally, the ZigBee module 103 delivers a digital audio signal received through the audio processor 130 to the relay station 150. More specifically, a reception port (e.g., an I2S Rx pin) of the ZigBee module 103 may be connected to an Analog-to-Digital Converter (ADC) 107 in the audio processor 130. Also, the ZigBee module 103 converts a digital audio signal being input from the ADC 107 into a radio signal and delivers the radio signal to the relay station 150.

The microphone 105 picks up an analog audio signal and delivers the analog audio signal to the audio processor 130, and the speaker 109 outputs an analog audio signal received from the audio processor 130.

The audio processor 130 converts an analog audio signal being input through the microphone 105 into a digital audio signal to provide the digital audio signal to the ZigBee module 103. The audio processor 130 converts a digital audio signal received from the ZigBee module 103 into an analog audio signal to output the analog audio signal to the speaker 109.

The relay station 150 includes a ZigBee module 151 and a controller 153.

The ZigBee module 151 performs wireless communication with the ZigBee module 103 in the terminal 100. More specifically, the ZigBee module 151 receives a radio signal from the terminal 100, converts the received radio signal into a digital audio signal, and delivers the digital audio signal to the controller 153. The ZigBee module 151 converts a digital audio signal received from the communication network 200 via the controller 153 into a radio signal, and transmits the radio signal to the ZigBee module 103 in the terminal 100.

The controller 153 analyzes a data signal received from the ZigBee module 151, and performs a set operation according to the type of the signal. The set operation of the controller 153 will be described in the related section.

The communication system, according to the exemplary embodiment as described with reference to FIGS. 1 and 2, uses local wireless communication, thus allowing movement of a terminal to not be restricted by wire connections. In addition, compared with the conventional technology requiring an access to the SLIC, the novel communication system may ensure the simple circuit design and reduce the power consumption.

For user convenience, a remote controller function may be added to terminals used for the above communication system, and a description thereof will be made with reference to FIGS. 1 and 3.

FIG. 3 illustrates a structure of a terminal according to another exemplary embodiment of the present invention.

Referring to FIGS. 1 and 3, a communication system, according to another exemplary embodiment of the present invention, includes a terminal 100 and a relay station 150.

The terminal 100 and the relay station 150 perform wireless communication with each other using their respective local wireless communication modules, namely the respective ZigBee modules 103 and 151. The relay station 150 converts a radio signal received from the terminal 100 into a digital signal to deliver the digital signal to a communication network 200. The relay station 150 converts a digital signal received from the communication network 200 into a radio signal to deliver the radio signal to the terminal 100. The communication network 200 includes various wired and wireless networks.

The terminal 100 includes a key input unit 101, a ZigBee module 103, a microphone 105, an audio processor 130, and a speaker 109.

The key input unit 101 includes at least one numeric key for inputting a number, a function key for inputting a function of an external device, and a mode switching key for switching between a remote controller mode and a VoIP terminal mode.

The remote controller mode refers to a mode used to control an external device such as a Television (TV) set, while the VoIP terminal mode refers to a mode used to perform VoIP communication with the other party's terminal.

The terminal 100 operates in the remote controller mode or the VoIP terminal mode according to a manipulation of the mode switching key by the user. The mode switching key may be connected to, for example, a General Purpose Input/Output (GPIO) pin of the ZigBee module 103. The ZigBee module 103 receives a switching signal, indicating a switching to the remote controller mode or the VoIP terminal mode, from the mode switching key through the GPIO pin, and performs mode switching according to the received switching signal. To this end, the key input unit 101 delivers the received mode switching signal to the ZigBee module 103.

In the remote controller mode, the key input unit 101 receives a function key input or at least one numeric key input for controlling an external device, generates a signal corresponding to the received key input, and delivers the generated signal to the ZigBee module 103. For example, the numeric key and the function key may be connected to a KeyScan pin of the ZigBee module 103, and the ZigBee module 103 generates a radio signal so as to perform an operation corresponding to at least one numeric key input or a function key input being received through the KeyScan pin. The ZigBee module 103 transmits the radio signal to various external devices, such as a TV set, making it possible to control the device associated with the key input.

The system may be configured to control the external device through the relay station 150, instead of directly controlling the external device by transmitting a radio signal by means of the terminal 100. For example, a control signal corresponding to a numeric key input or a function key input is received from the key input unit 101. The ZigBee module 103 converts the control signal and a specific signal indicating that the current mode is the remote controller mode into a radio signal and transmits the radio signal.

In the VoIP terminal mode, the key input unit 101 receives from a user at least one numeric key input for calling the other party's terminal, generates a signal corresponding to the received key input, and delivers the generated signal to the ZigBee module 103. For example, the numeric key may be connected to the KeyScan pin, and the ZigBee module 103 receives a signal for calling the other party's terminal from the numeric key input through the KeyScan pin. The ZigBee module 103 converts the received signal into a radio signal, and transmits the radio signal to the relay station 150.

The ZigBee module 103 delivers a digital audio signal received from the other party's terminal to the audio processor 130 through the relay station 150. More specifically, a transmission port (e.g., an I2S Tx pin) of the ZigBee module 103 may be connected to a DAC 111 in the audio processor 130, and the ZigBee module 103 delivers the digital audio signal received through the relay station 150 to the DAC 111.

Also, the ZigBee module 103 delivers a digital audio signal, received through the audio processor 130, to the relay station 150. More specifically, a reception port (e.g., an I2S Rx pin) of the ZigBee module 103 may be connected to an ADC 107 in the audio processor 130. The ZigBee module 103 converts a digital audio signal being input from the ADC 107 into a radio signal and delivers the radio signal to the relay station 150.

The microphone 105 picks up an analog audio signal and delivers the analog audio signal to the audio processor 130, and the speaker 109 outputs an analog audio signal received from the audio processor 130.

The audio processor 130 converts an analog audio signal being input through the microphone 105 into a digital audio signal to provide the digital audio signal to the ZigBee module 103. The audio processor 130 converts a digital audio signal received from the ZigBee module 103 into an analog audio signal to output the analog audio signal to the speaker 109.

The relay station 150 includes a ZigBee module 151 and a controller 153.

The ZigBee module 151 performs wireless communication with the ZigBee module 103 in the terminal 100. More specifically, the ZigBee module 151 receives a radio signal from the terminal 100, converts the received radio signal into a digital audio signal, and delivers the digital audio signal to the controller 153. Also, the ZigBee module 151 converts a digital audio signal received from the communication network 200, via the controller 153, into a radio signal. The ZigBee module 151 also transmits the radio signal to the ZigBee module 103 in the terminal 100.

Furthermore, the ZigBee module 151 receives a radio signal from the terminal 100 and delivers numeric information included in the received radio signal to the controller 153. The controller 153 processes the received numeric information to call the other party's terminal and delivers the processing results to the communication network 200. The controller 153, serving as a modem, exchanges call signals with the other party's terminal over the communication network 200.

The controller 153 delivers a digital audio signal, which is received from the other party's terminal, to the ZigBee module 151. The controller 153 also delivers a digital audio signal received from the terminal 100, via the ZigBee module 151, to the communication network 200.

According to the exemplary embodiments of FIGS. 1 and 3, a control signal for controlling the external device may be transmitted using a local wireless communication interface used to provide a VoIP service.

The configuration and roles of the communication system according to exemplary embodiments of the present invention have been described so far. An operation of the communication system according to exemplary embodiments of the present invention will now be described below with reference to the accompanying drawings.

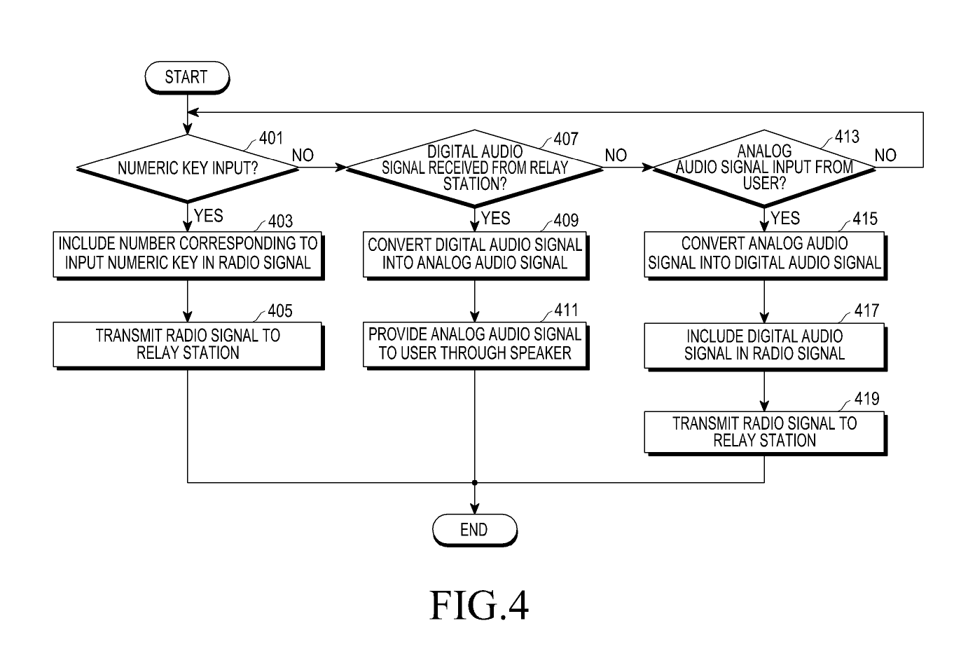

FIG. 4 illustrates an operation of a terminal 100 in a communication system according to an exemplary embodiment of the present invention.

Referring to FIG. 4, the terminal 100 determines in step 401 whether a numeric key for calling the other party's terminal has been input through a key input unit 101. If so, the terminal 100 proceeds to step 403, and if not, the terminal 100 proceeds to step 407.

In step 403, the terminal 100 converts a signal corresponding to the input numeric key into a radio signal. After the signal conversion, the terminal 100 transmits the radio signal to a relay station 150 in step 405.

On the other hand, in step 407, the terminal 100 determines if a digital audio signal has been received from the relay station 150. If so, the terminal 100 proceeds to step 409, and if not, the terminal 100 proceeds to step 413.

In step 409, the terminal 100 converts the received digital audio signal into an analog audio signal. After the signal conversion, the terminal 100 provides the converted analog audio signal to a user through a speaker 109 in step 411.

On the other hand, in step 413, the terminal 100 determines if an analog audio signal has been input by the user through a microphone 105. If so, the terminal 100 proceeds to step 415, and if not, the terminal 100 returns to step 401.

In step 415, the terminal 100 converts the input analog audio signal into a digital audio signal. After the signal conversion, the terminal 100 converts the converted digital audio signal into a radio signal in step 417, and transmits the radio signal to the relay station 150 in step 419.

Through this operation, the terminal 100 may perform VoIP communication with the other party's terminal.

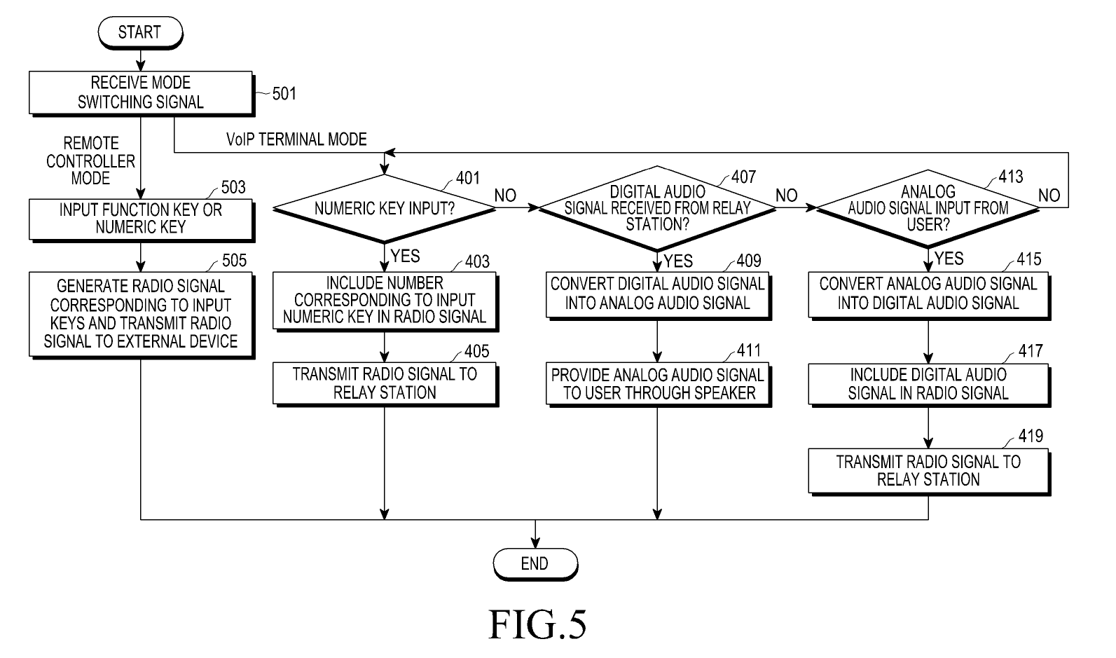

FIG. 5 illustrates an operation of a terminal 100 in a communication system according to another exemplary embodiment of the present invention.

Referring to FIG. 5, in step 501, the terminal 100 receives a mode switching signal input by a user through a key input unit 101. If the mode switching signal indicates switching to a remote controller mode, the terminal 100 proceeds to step 503, and if the mode switching signal indicates switching to a VoIP terminal mode, then the terminal 100 proceeds to step 401.

In step 503, the terminal 100 receives at least one function key input or at least one numeric key input by a user.

In step 505, the terminal 100 generates a radio signal corresponding to the function key input or numeric key input received in step 503, and transmits the generated radio signal to an external device, thereby controlling the external device.

The system may be configured to control the external device through a relay station 150, instead of directly controlling the external device by transmitting a radio signal by means of the terminal 100. For example, a control signal corresponding to a numeric key input or a function key input is received from the key input unit 101. The ZigBee module 103 converts the control signal and a specific signal indicating that the current mode is the remote controller mode into a radio signal and transmits the radio signal.

An operation in the VoIP terminal mode, performed in steps 401 to 419, is the same as that described in connection with FIG. 4, so a detailed description thereof will be omitted.

Through this operation, the terminal 100 may serve as a remote controller controlling the external device, in addition to performing VoIP communication with the other party's terminal.

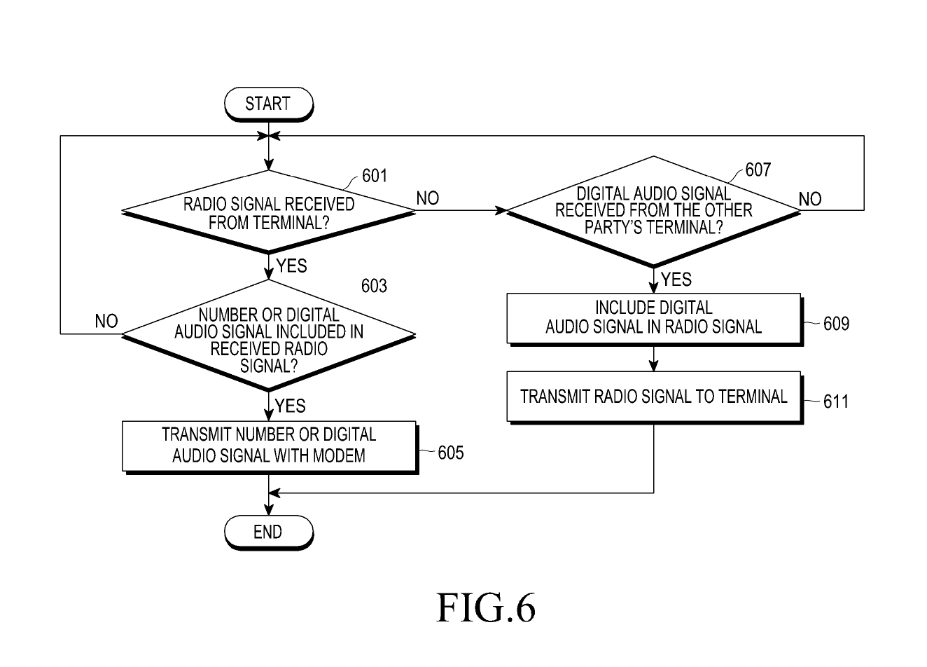

FIG. 6 illustrates an operation of a relay station 150 in a communication system according to exemplary embodiments of the present invention, in which the relay station 150 operates in a VoIP terminal mode.

Referring to FIG. 6, a controller 153 of the relay station 150 determines in step 601 whether a radio signal has been received from a terminal 100 through a ZigBee module 151. If so, the controller 153 proceeds to step 603, and if not, the controller 153 proceeds to step 607.

In step 603, the controller 153 determines if numeric information or a digital audio signal is included in the received radio signal. If so, the controller 153 proceeds to step 605, and if not, the controller 153 returns to step 601.

In step 605, the controller 153 transmits the numeric information or digital audio signal included in the received radio signal to a communication network 200, for communication between the terminal 100 and the other party's terminal.

On the other hand, in step 607, the controller 153 determines if a digital audio signal to be transmitted to the terminal 100 has been received from the other party's terminal over the communication network 200. If so, the controller 153 proceeds to step 609, and if not, the controller 153 returns to step 601.

In step 609, the controller 153 delivers the received digital audio signal to a ZigBee module 151, and the ZigBee module 151 converts the received digital audio signal into a radio signal. In step 611, the ZigBee module 151 transmits the radio signal to the terminal 100 to enable communication between the other party's terminal and the terminal 100.

As discussed in the foregoing description, by providing a VoIP service using local wireless communication, exemplary embodiments of the present invention may expand coverage of a terminal, contributing to a reduction in system complexity and lower power consumption by a communication system providing the VoIP service.

In addition, by transmitting a radio signal for controlling an external device by means of a local wireless communication interface used to provide VoIP services, exemplary embodiments the present invention may control the external device.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A communication terminal for servicing wireless communication with a relay station, the communication terminal comprising:
a local wireless communication unit for transmitting and receiving an audio signal for a Voice over Internet Protocol (VoIP) service through wireless communication with the relay station, for converting a radio signal received from the relay station into a digital audio signal to output the digital audio signal, and for converting an input digital audio signal into a radio signal to transmit the radio signal to the relay station; and
an audio processor for converting the digital audio signal received from the local wireless communication unit into an analog audio signal to output the analog audio signal, and for converting an input analog audio signal into a digital audio signal to deliver the digital audio signal to the local wireless communication unit.

2. The communication terminal of claim 1, further comprising a key input unit, comprising:
a mode switching key for requesting a switching to a remote controller mode for controlling at least one external device; and
at least one control key for controlling the at least one external device in the remote controller mode,
wherein after the switching to the remote controller mode according to an input from the mode switching key, the local wireless communication unit converts a control signal generated to correspond to an input from the at least one control key into a radio signal, and transmits the radio signal to the at least one external device.

3. The communication terminal of claim 1, further comprising a key input unit, comprising:
a mode switching key for requesting a switching to a remote controller mode for controlling at least one external device; and
at least one control key for controlling the at least one external device in the remote controller mode,
wherein, upon receiving a key input for requesting the switching to the remote controller mode, the local wireless communication unit converts a signal for the requesting of the switching to the remote controller mode and a control signal corresponding to an input from the at least one control key into a radio signal, and transmits the radio signal to the relay station.

4. The communication terminal of claim 1, wherein the local wireless communication unit performs Bluetooth or ZigBee communication.

5. The communication terminal of claim 1, wherein the audio processor comprises:
a Digital to Analog Converter (DAC) for the converting of the digital audio signal into the analog audio signal; and
an Analog to Digital Converter (ADC) for the converting of the input analog audio signal into the digital audio signal.

6. A relay station for servicing wireless communication with a terminal, the relay station comprising:
a local wireless communication unit for transmitting and receiving an audio signal for a Voice over Internet Protocol (VoIP) service through wireless communication with the terminal, for converting a radio signal received from the terminal into a digital audio signal to output the digital audio signal, and for converting an input digital audio signal into a radio signal to transmit the radio signal to the terminal; and
a controller for transmitting the digital audio signal received from the local wireless communication unit to a communication network, for converting a digital audio signal received from the communication network into a radio signal, and for delivering the radio signal to the local wireless communication unit.

7. The relay station of claim 6, wherein the local wireless communication unit transmits a control signal for controlling at least one external device to the at least one external device, upon receiving, from the terminal, a radio signal,
wherein the radio signal comprises a signal indicating a remote controller mode for controlling the at least one external device, and a control signal for controlling the at least one external device in the remote controller mode.

8. A method for providing a service in a communication terminal servicing wireless communication with a relay station, the method comprising:
converting an analog audio signal input from a user into a first digital audio signal;
converting the first digital audio signal into a radio signal;
transmitting the radio signal to the relay station;
converting a radio signal received from the relay station into a second digital audio signal;
converting the second digital audio signal into an analog audio signal; and
providing the analog audio signal to the user.

9. The method of claim 8, further comprising:
switching to a remote controller mode upon a request for switching to a remote controller mode for controlling at least one external device;
receiving a key input for controlling the at least one external device in the remote controller mode;
converting a control signal generated to correspond to the key input into a radio signal; and
transmitting the radio signal to the at least one external device.

10. The method of claim 9, further comprising switching to a voice terminal mode upon a request for switching to a voice terminal mode.

11. The method of claim 9, wherein the switching to the remote controller mode occurs before the converting of the analog audio signal input from the user into the first digital audio signal.

12. The method of claim 8, further comprising:
receiving a mode switching request signal for requesting switching to a remote controller mode for controlling at least one external device;
receiving a key input for controlling the at least one external device after receiving the mode switching request signal;
converting a signal for the requesting of the switching to the remote controller mode and a control signal corresponding to the key input into a radio signal; and
transmitting the radio signal to the relay station.

13. The method of claim 8, further comprising:
receiving a numeric key input;
including the numeric key input in the radio signal; and
transmitting the radio signal to the relay station.

14. The method of claim 8, wherein the transmitting of the radio signal to the relay station is performed using Bluetooth or ZigBee communication.

15. A method for providing a service in a relay station servicing wireless communication with a communication terminal, the method comprising:
converting a radio signal received from the communication terminal into a digital audio signal;
transmitting the digital audio signal to a communication network;
converting a digital audio signal received from the communication network into a radio signal; and
transmitting the radio signal to the communication terminal.

16. The method of claim 15, further comprising transmitting a control signal for controlling at least one external device to the at least one external device, upon receiving, from the communication terminal, a radio signal,
wherein the radio signal comprises a signal indicating a remote controller mode for controlling the at least one external device, and a control signal for controlling the at least one external device in the remote controller mode.

17. The method of claim 15, wherein the radio signal is one of a Bluetooth signal or a ZigBee signal.
